(19) United States
(12) Patent Application Publication
(10) Pub. No.: US 2021/0305880 A1
(43) Pub. Date: Sep. 30, 2021

(54) GYRATION ENERGY GENERATOR

(71) Applicant: GYNERXY HK LIMITED, Hong Kong (HK)

(72) Inventors: TUCK LOONG CHAANG, HONG KONG (HK); JASON LEO, HONG KONG (HK); BOON HAN LIM, HONG KONG (HK)

(73) Assignee: GYNERXY HK LIMITED, HONG KONG (HK)

(21) Appl. No.: 17/343,194

(22) Filed: Jun. 9, 2021

Related U.S. Application Data
(63) Continuation-in-part of application No. 16/250,656, filed on Jan. 17, 2019.
(60) Provisional application No. 62/620,491, filed on Jan. 23, 2018.

(51) Int. Cl. H02K 7/02; F03G 3/08

(52) U.S. Cl. CPC H02K 7/025; F16H 33/02; F03G 3/08

(57) ABSTRACT

A device for generating electricity includes a rotatable flywheel assembly including at least one flywheel and an axle rotatable about a first axis to spin the flywheel, a support means to suspend the rotatable assembly and to allow the flywheel assembly to rotate with respect to the support means about a second axis to perform rotary motion normal to the first axis, and track means contactable with at least one free end of the axle for augmenting the spinning of the flywheel while it is also in rotary motion about both the first and second axes, wherein the rotating assembly is initially rotated to induce the spinning motion of the flywheel and the axle until the flywheel has a predetermined rotational energy, the flywheel assembly being engaged with an electrical generator for converting the spinning motion of the flywheel assembly into electricity, wherein the track means is configured to provide augmenting rotation to the flywheel assembly in at least an intermittent manner.

### CROSS-REFERENCE TO RELATED APPLICATION

The instant application is a continuation in part of U.S. patent application Ser. No. 16/250,656 filed Jan. 17, 2019, pending, and claims priority to U.S. Provisional Patent Application Ser. No. 62/620,491 filed Jan. 23, 2018, the entire specifications of both of which are expressly incorporated herein by reference.

### FIELD OF THE INVENTION

The invention relates to a power supply unit. More particularly, the invention relates to an electric generator for converting gravitational gyration energy into electricity.

### BACKGROUND OF THE INVENTION

In order to satisfy our daily electrical power requirements and to avoid “black outs,” a variety of techniques have been and are being developed to generate energy from various sources, such as the coal, oil, natural gas, hydrogen, sunlight, wind, and ocean waves. Certain energy resources are limited on earth and are not renewable. Examples of such energy sources include the fossil fuels like coal, oil, and natural gas, and nuclear fuels such as uranium. Such resources will eventually be depleted on earth by continuous exploration and use. Furthermore, the consumption and use of many non-renewable energy sources such as fossil fuels and nuclear fuels will produce by-products that are also known for causing pollutions to the environments.

On the other hand, renewable energy resources such as the sunlight, wind, and ocean waves are practically unlimited in their supply and can be utilized in numerous ways to significantly reduce or minimize impacts to the environments and the earth's ecological systems. Therefore, techniques, devices and systems for obtaining energy from various sources other than fossil fuels and nuclear fuels are desirable to preserve earth's natural resources, to reduce pollution to the environments, and to expand energy supply sources in order to provide sustainable energy supply.

### SUMMARY OF THE INVENTION

In one aspect of the invention, there is provided a device for generating electricity comprises a rotatable flywheel assembly including at least one flywheel and an axle rotatable about a first axis to spin the flywheel; a support means to suspend the rotatable assembly and to allow the flywheel assembly to rotate with respect to the support means about a second axis to perform rotary motion normal to the first axis; and track means contactable with at least one free end of the axle for augmenting the spinning of the flywheel while it is also in rotary motion about both the first and second axes; wherein the rotating assembly is initially rotated to induce the spinning motion of the flywheel and the axle until the flywheel has a predetermined rotational energy, the flywheel assembly being engaged with an electrical generator for converting the spinning motion of the flywheel assembly into electricity, wherein the track means is configured to provide augmenting rotation to the flywheel assembly in at least an intermittent manner.

Preferably, the support means may include a rotatable base and a pair of spaced apart bearings, wherein each bearing is extended from the base to either side of the flywheel for the axle to be rotatably mounted thereon.

Preferably, the track means may include a pair of spaced apart circular tracks, one positioned above the other with a gap therebetween, wherein the gap is sized for the free ends of the axle to travel within the gap.

Alternatively, the circular tracks can be tilted in an intermittent manner such that a bottom surface of the upper track moves downwardly to contact with one end of the axle and a top surface of the bottom track moves upwardly to contact with the opposing end of the axle so that the augmenting rotation can be provided to the axle.

Alternatively, the flywheel assembly can be tilted in an intermittent manner by the support means such that one end of the axle moves upwardly to contact with a bottom surface of the upper track and the opposing end of the axle moves downwardly to contact with a top surface of the bottom track so that the augmenting rotation can be provided to the axle.

Alternatively, the free ends of the axle can be each sized and positioned in a way such that one free end is constantly in contact with only a bottom surface of the upper track and the other free end is constantly in contact with only an upper surface of the bottom track.

Preferably, each end of axle can be coupled with a pair of spaced apart one way bearings to form a section between the pair of one way bearings that has free motion in a direction opposing to the spinning direction of the flywheel assembly and wherein the electrical generator is engaged with the section.

Alternatively, the electrical generator can be mounted at the center of flywheel and extended through the center of the flywheel to centralize the center of gravity while in the motions.

Alternatively, the flywheel assembly may comprise two flywheels and the electrical generator is extended through the center of both the flywheels, whereby a rotor of the electrical generator is mounted to one flywheel, a stator of the electrical generator is mounted to the other flywheel and the rotor and the stator are rotating in opposing directions.

Alternatively, the axle can be coupled with a reverse gear so that the two ends of the axles will be spinning in an opposing direction.

Alternatively, the support means may further include a pair of spaced one way bearings and a flywheel positioned between the bearings, whereby the flywheel is rotatable about the second axis.

Preferably, a drive motor can be provided to initial the rotary motion of the flywheel assembly, wherein the drive motor is powered by renewable energy or non-renewable energy, and the drive motor installed with a timer switch that controls the ON/OFF of its power supply at pre-programmed intervals.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a schematic diagram illustrating a gyration energy generator which embodies therein the principle features of the invention.

FIG. 2 shows an exemplary arrangement for a flywheel assembly.

FIG. 3 shows a further exemplary arrangement for the flywheel assembly.

FIG. 4 shows a further exemplary for an axle of the flywheel assembly.

FIG. 5 shows a second embodiment of the gyration energy generator.

### DETAILED DESCRIPTION OF THE INVENTION

The invention will now be described in greater detail, by way of example, with reference to the drawings.

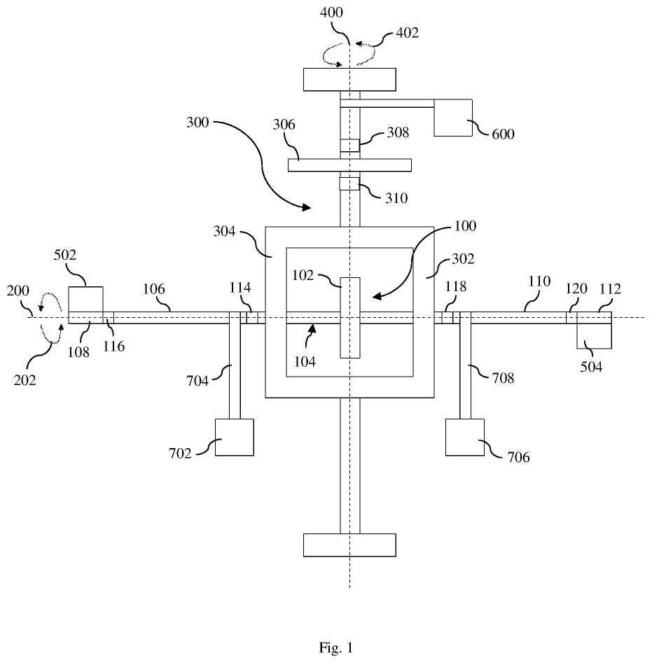

Referring to FIG. 1, the preferred embodiment of a gyration energy generator is illustrated. Although, the invention can be implemented in a number of different ways, and incorporating a variety of different components and technologies, the various embodiments of the invention are built on a combination of two major concepts: firstly, on the law of conservation of angular momentum, and secondly, on gear ratio.

The key components of the generator comprise a rotatable flywheel assembly 100, a support means 300 and a track means 502, 504. Preferably, the rotatable flywheel assembly 100 includes at least one flywheel 102 with an axle 104 rotatable about a first axis 200 to form a spinning motion 202. The flywheel 102 is an efficient rotating mechanical device for storing rotational energy while it is in the spinning motion 202 and is further configured to release the stored rotational energy in a later stage. The amount of energy stored in the flywheel 102 is proportional to its weight and rotation speed. Each end of the axle 104 has a pair of one way bearings 114-120 incorporated there along, the one way bearings 114-120 are spaced apart from each other forming sections 106-112 that have free motion in an opposing direction to the spinning motion 202 of the flywheel assembly 100.

The structure of the support means 300 is configured to suspend the flywheel assembly 100 above ground and to allow the flywheel assembly 100 to rotate in full revolutions with respective to the support means 300 for gyrating the flywheel assembly about a second axis 400 to form a gyration motion 402. Preferably, the support means 300 includes a pair of bearings 302, 304 for the axle 104 of the flywheel assembly 100 to be rotatably mounted thereon. The bearings 302, 304 can be pillow block bearings that enable the axle 104 to rotate freely and they are spaced apart from each other. The flywheel 102 is preferably positioned at a location between the bearings 302, 304.

As shown in FIGS. 1 and 5, the support means 300 may further comprise a flywheel 306 rotatable about the second axis 400, being positioned between a pair of one way bearings 308, 310 to provide free motion in a direction opposing to the gyration motion 402 to a section of the flywheel 306. Similar to flywheel 102, the flywheel 306 is configured to store rotational energy from the gyration motion 402 about the second axis 400 and to release the stored rotational energy for maintaining the motions 202, 402 in a later stage.

The track means 502, 504 is in contact with at least one free end 108, 112 of the axle 104 for spinning the flywheel assembly 100 while it is in the gyration motion 402. Preferably, the track means 502, 504 includes a pair of spaced apart circular tracks 502, 504, one 502 positioned above the other 504 leaving a gap in between to fit in the axle 104. The gap is sized for the free ends 108, 112 of the axle 104 to travel within the gap without contacting with any of the circular tracks 502, 504 before the generator is being initiated. The track means 502, 504 may include one or more rotating rollers to provide additional rotational thrust to maintain the spinning motion 202 of the flywheel 306 when the free end 108, 112 of the axle 104 and the track means 502, 504 are in contact with each other.

There are certain ways to manipulate the axle 104 and/or the track means 502, 504 so that the two can be in contact with each other during the operation. The examples of such manipulation are as follows:

1) tilting the circular tracks 502, 504 in an intermittent manner such that a bottom surface of the upper track 502 moves downwardly to contact with the end 108 of the axle 104 and a top surface of the bottom track 504 moves upwardly to contact with the opposing end gyration energy generator of the axle 104;

2) tilting the flywheel assembly 100 in an intermittent manner such that one end 108 of the axle 104 moves upwardly to contact with a bottom surface of the upper track 502 and the opposing end 112 of the axle 104 moves downwardly to contact with a top surface of the bottom track 504;

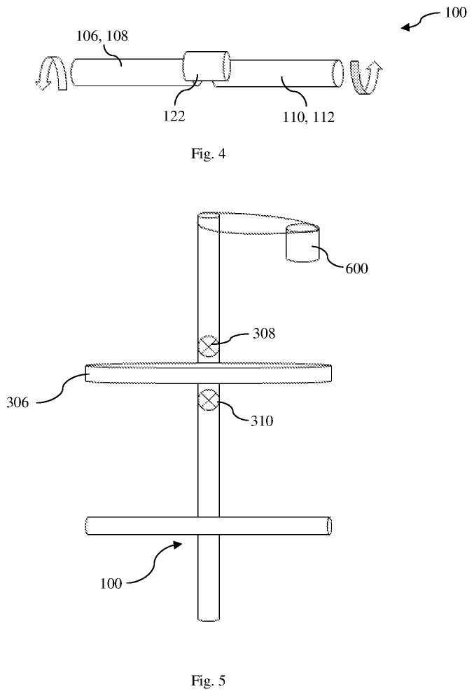

3) as shown in FIG. 4, the axle 104 can be in the form of two separate shafts that are joined by a reverse gear 122 so that the two shafts can each rotate in an opposing direction to each other while the axle 104 is gyrating on the track means 502, 504. As such, the free ends 108, 112 of the axle 104 can always in contact with the same track and only one circular track is needed for this arrangement instead of two; and

4) the free ends 108, 112 of the axle 104 are each sized and positioned in a way such that the free end 108 is constantly in contact with only a bottom surface of the upper track 502 and the free end 112 is constantly in contact with only an upper surface of the bottom track 504.

The tilting of track means 502, 504 or the flywheel assembly 100 can be controlled by a control unit mechanically or electrically. The contacts happen intermittently to keep the flywheel assembly 100 continuously, and hence enabling electricity to be generated continuously. In addition to the options (1) and (2) toward achieving intermittent contacts, both flywheel assembly 100 and the track means 502, 504 can be tilted, as long as they can be controlled to allow the intermittent contacts to happen at certain desired fixed intervals.

In stage 1 of the operation, the flywheel assembly 100 is firstly gyrated by a drive motor 600 to form the gyration motion 402. The gyration motion 402 and the contact between the axle 104 and the track means 502, 504 will induce the spinning motion 202 for the flywheel assembly 100. The drive motor 600 can be powered by renewable energy or even non-renewable energy such as biomass, hydropower, geothermal, wind, solar, fossil fuels and nuclear fuels. The drive motor 600 can have two drive modes. In the first mode, the drive motor 600 continuously provide energy to drive the gyration motion. In the second mode, the drive motor 600 can be installed with a timer switch that controls the ON/OFF of its power supply at pre-programmed intervals to achieve maximum efficiency. The optimum interval is the set of combination that requires the least energy input to produce the highest net power output.

In stage 2 of the operation, when the spinning motion 202 of the flywheel assembly 100 reaches a certain high speed, at least one end of the axle 104 will be further engaged by one or more electrical generators 702, 706 for converting the spinning motion 202 into electricity. Preferably, the electrical generators 702, 706 are engaged to sections 106 and 110 of the axle 104 by their respective linkage belts 704, 708. The produced electricity can be stored by a battery system for later usage. The produced electricity can also be redirected to drive the rotating rollers of the track means 502, 504 to maintain the spinning motion 202 for the flywheel assembly 100.

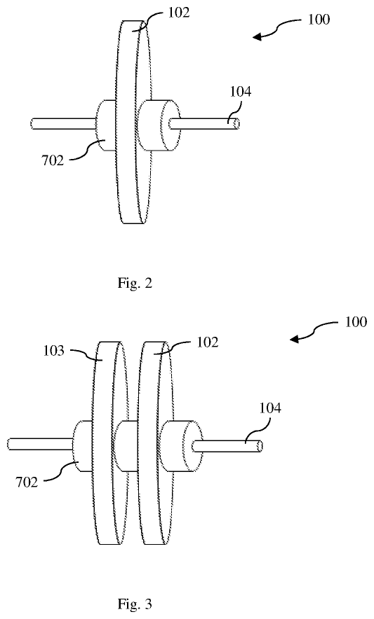

Referring to FIG. 2, a first arrangement of the flywheel assembly 100 as illustrated therein comprises a flywheel 102 with an axle 104 and an electrical generator 702. The electrical generator 702 is installed at and extended through the center of the flywheel 102. The benefit of this arrangement is that the center of mass is centralized on the axle 104, resulting in less energy required to gyrate the flywheel assembly 100, in accordance to the law of angular momentum.

As compared to the above arrangement, its second alternative embodiment as shown in FIG. 3 further comprises an additional flywheel 103 and the electrical generator 702 is extended through the center of both flywheels 102, 103. However, the components of the electrical generator 702 will rotate in two opposing directions with their respective rotor/shaft rotates in clockwise, and their respective stator casing rotates in anti-clockwise or vice versa. Preferably, each part of the electrical generator 702 will be mounted to one flywheel 102, 103. This arrangement will result in doubling the rotation rate for the electrical generator 702 and thereby generating twice the amount of electricity given the same gyration rate of the axle 104.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

What is claimed is:

1. A device for generating electricity comprising:
a rotatable flywheel assembly including at least one flywheel and an axle rotatable about a first axis to spin the flywheel;
a support means to suspend the rotatable assembly and to allow the flywheel assembly to rotate with respect to the support means about a second axis to perform rotary motion normal to the first axis; and
track means contactable with at least one free end of the axle for augmenting the spinning of the flywheel while it is also in rotary motion about both the first and second axes;
wherein the rotating assembly is initially rotated by a drive motor to induce the spinning motion of the flywheel and the axle until the flywheel has a predetermined rotational energy, the flywheel assembly being engaged with an electrical generator for converting the spinning motion of the flywheel assembly into electricity, wherein the track means is configured to provide augmenting rotation to the flywheel assembly in at least an intermittent manner.

2. The device according to claim 1, wherein the support means includes a rotatable base and a pair of spaced apart bearings, wherein each bearing is extended from the base to either side of the flywheel for the axle to be rotatably mounted thereon.

3. The device according to claim 1, wherein the track means includes a pair of spaced apart circular tracks, one positioned above the other with a gap therebetween, wherein the gap is sized for the free ends of the axle to travel within the gap.

4. The device according to claim 3, wherein the circular tracks are tilted in an intermittent manner such that a bottom surface of the upper track moves downwardly to contact with one end of the axle and a top surface of the bottom track moves upwardly to contact with the opposing end of the axle so that the augmenting rotation can be provided to the axle.

5. The device according to claim 3, wherein the flywheel assembly is tilted in an intermittent manner by the support means such that one end of the axle moves upwardly to contact with a bottom surface of the upper track and the opposing end of the axle moves downwardly to contact with a top surface of the bottom track so that the augmenting rotation can be provided to the axle.

6. The device according to claim 3, wherein the free ends of the axle are each sized and positioned in a way such that one free end is constantly in contact with only a bottom surface of the upper track and the other free end is constantly in contact with only an upper surface of the bottom track.

7. The device according to claim 6, wherein each end of axle is coupled with a pair of spaced apart one way bearings to form a section between the pair of one way bearings that has free motion in a direction opposing to the spinning direction of the flywheel assembly and wherein the electrical generator is engaged with the section.

8. The device according to claim 7, wherein the electrical generator is mounted at the center of flywheel and extended through the center of the flywheel to centralize the center of gravity while in the motions.

9. The device according to claim 8, wherein the flywheel assembly comprises two flywheels and the electrical generator is extended through the center of both the flywheels, whereby a rotor of the electrical generator is mounted to one flywheel, a stator of the electrical generator is mounted to the other flywheel and the rotor and the stator are rotating in opposing directions.

10. The device according to claim 9, wherein the axle is coupled with a reverse gear so that the two ends of the axles will be spinning in an opposing direction.

11. The device according to claim 10, wherein the support means further includes a pair of spaced one way bearings and a flywheel positioned between the bearings, whereby the flywheel is rotatable about the second axis.

12. The device according to claim 11, wherein the drive motor is powered by renewable energy or non-renewable energy, and the drive motor installed with a timer switch that controls the ON/OFF of its power supply at pre-programmed intervals.
